(19) United States
(12) Patent Application Publication
(10) Pub. No.: US 2013/0167869 A9
(43) Pub. Date: Jul. 4, 2013

(54) FLOOR GRINDING AND CLEANING BODY

(71) Applicant: Peter Jost, Abtsteinach (DE)

(72) Inventor: Peter Jost, Abtsteinach (DE)

(21) Appl. No.: 13/576,353

(22) PCT Filed: Feb. 4, 2011
(86) PCT No.: PCT/EP2011/051667

§ 371 Date: Jul. 31, 2012

(30) Foreign Application Priority Data
Feb. 10, 2010 (DE) 10 2010 001 769.8
Oct. 12, 2010 (EP) 10187301.6

(51) Int. Cl. B24B 1/00; A47L 11/02; B24B 7/00; B08B 1/04

(52) U.S. Cl. 134/6; 451/28; 451/73

(57) ABSTRACT

Floor grinding- and cleaning body (1) for machine-based processing of structured floorings (2) comprising a base body (10) which is provided on a first side (12) with a resilient, textured surface (14), a processing layer (20) that is arranged on the textured surface (14) of the base body (10) and a hook-and-loop adaption layer (30), which is arranged on a second side (16) of the base body (10) opposed to the first side (12), wherein the textured surface (14) comprises a resilient burling structure, wherein the burls (18) thereof are designed to be able to treat deep areas (4) of a structured surface (3) of a flooring (2).

### 1. FIELD OF THE INVENTION

The invention relates to a floor grinding- and cleaning-body for machine-based processing of structured floorings. The floor grinding- and cleaning-bodies are used in order to clean floorings made of polymer with structured surfaces that are difficult to clean. The floor grinding- and cleaning-bodies can also be used to grind structured floorings in order to coat them again.

### 2. PRIOR ART

Floors made of polymer are used in many fields of application, for instance, in healthcare, in industry and business, airports, office and administration buildings as well as in residential buildings. Besides floorings made of polymer with a planar surface, floorings made of polymer are available with a distinctive, i.e. macroscopic, tactual and well-visible surface structure that makes the floorings appear more natural or reduce the danger of slipping. For instance, floorings are known with a shale structure, wood structure, hammer blow surface or with round burling. The structure of such floors may comprise the height from about 0.3 mm up to some millimeters and thus differs significantly from essentially smooth floorings with common microscopic surface roughness.

A thorough cleaning or grinding of such floorings with distinctive surface structure constitutes a big problem, which has not been optimally solved up to now. Known cleaning products and systems, like, for instance, brushing machines with brush drums or single-disc machines, trio-machines or automatic cleaning machines that are used in combination with grinding or cleaning pads do not reach deeper areas of the textured surface, so that a thorough cleaning or processing of the whole surface is not possible. In particular, dirt from deeper areas of the textured surface can be removed only insufficiently, since the grinding or cleaning means only reach the elevated areas of the structured surface of the flooring. A single-disc machine of this type with a corresponding polishing pad is known from U.S. Pat. No. 5,458,532.

When soft brush drums are used, the deeper areas of the surface structure of the floor are reached indeed, but the overall cleaning effect is very low.

In order to increase the service life of the polymer floors and to improve the optical appearance of the floors, floors made of polymer are also coated with PU lacquer. During refurbishment work of such PU-coated floorings, the old PU coating has to be ground off before the floor can be coated again. However, there are no known grinding products from prior art that could be used for thoroughly grinding structured floorings. Also resilient grinding discs always grind only the elevations of the flooring, while the deepenings remain unprocessed.

From DE 202 15 389 U1, a grinding body in particular for cleaning of surfaces is known which comprises a base body which at least comprises a grinding means on one side, while the base body comprises elevations on the side where the grinding means are present. Through this, it can be achieved in an advantageous manner that substances that are detached from the surface to be grinded or polished or abrasion of the grinding body can be accumulated in the cavities that are generated by the elevations. Moreover, the elevations have the effect that the abrasion of the grinding body is increased. Agents embedded in additional means shall be dispensed in a more selective manner by the elevations. However, it is not apparent how such a cleaning body would be appropriate for the machine-based processing of structured floorings.

An abrasive sheet-like grinding means of a carrier layer and a second layer made of glued-on elements is known from US 2008/0318506 A1. The second layer is coated with abrasive material. With such an arrangement, a network of tracks shall be formed between the elements of the second layer through which air and dust particles are evaporated during grinding, over the processed surface.

Furthermore, sponges for cleaning of pots and dishes are known which comprise a resilient, slightly textured surface. These sponges for cleaning of pots and dishes are used for manual dish cleaning. They do not have a defined removal rate and are, by principle, not appropriate for machine-based processing of floorings.

Furthermore, for instance from U.S. Pat. No. 5,185,964, polishing sponges with a resilient, textured surface are known that are used in combination with liquid polishing means for polishing of automobile lacquered surfaces. The polishing sponges themselves have no grinding or cleaning effect.

Thus, the present invention solves the problem of providing a grinding- and cleaning-body for machine-based processing of structured floorings.

### 3. SUMMARY OF THE INVENTION

The above-mentioned problem is solved by a floor grinding- and cleaning-body for machine-based processing of structured floorings according to patent claims 1 and 6, the use of such a floor grinding- and cleaning-body according to claim 20 and a method of machine-based processing of structured floorings according to claim 18.

In particular, the above-mentioned problem is solved by a floor grinding- and cleaning-body for machine-based processing of structured floorings, comprising a base body which is provided on a first side with a resilient, textured surface, a processing layer that is arranged on the textured surface of the base body and a hook-and-loop adaption layer which is arranged on a second side of the base body opposed to the first side, wherein the textured surface comprises a resilient burling structure, wherein the burls thereof are designed to be able to treat deep areas of a structured surface of a flooring.

Since the processing layer is arranged on a resilient textured surface of the base body, it is possible to reach also deep areas of the structure of a structured flooring by the floor grinding- and cleaning-body and thus also to grind or to clean the deep areas in a machine-based manner. The resilient texture presses the processing layer also into deep areas of the floor structure in order to carry out a processing on the bottom of these deep areas, i.e. a cleaning or a grinding. By means of the hook-and-loop adaption layer that is arranged on a second side of the base body opposed to the first side, the floor grinding- and cleaning-body can be attached easily and safely to a corresponding machine, whereby a good force transmission from the machine to the floor grinding- and cleaning-body is given.

The textured surface of the base body comprises a resilient burling structure. Due to the burling structure, elevations result on the base body, and also corresponding elevations on the processing layer, so that the processing layer is pressed by the base body into deeper areas of the structured surface of the flooring and can also process the deeper areas of the structured surface. Due to the resilience of the base body, the tips of the individual burls are pressed onto the bottom of the deepenings of the surface structure of the flooring and can clean or grind there, respectively. Furthermore, the resilience of the base body ensures that the individual burl in a floor grinding- and cleaning-body that moves relatively to the flooring carries out a roller coaster ride through the valleys and over the mountains of the structured surface. Accordingly, the burls stay always in contact with the structured surface of the flooring and thus process all surface areas of the floor essentially in the same manner, namely the valleys, the mountains and the transitions between mountain and valley. By the structured surface of the floor grinding- and cleaning-body, in addition, air is entrained during the grinding process and directed to the grinding surface, so that the grinding surface is cooled, which prevents a clogging of the floor grinding- and cleaning-body and enhances the grinding result. In addition, the generated grinding dust is removed from the grinding surface.

Preferably, the textured surface comprises a resilient burling structure which is adapted to the textured surface of the flooring to be processed. By the adaption of the burling structure to the surface structure of the flooring, a sufficient grinding pressure is applied to the deep areas of the flooring by the single burl, although other burls rest on the elevated areas of the flooring and thus are compressed more strongly. The adaption of the burling structure to the flooring to be processed can be carried out, for instance, in view of the elasticity, the shape, the arrangement, the distance and the size of the burls of the burling structure.

Preferably, the processing layer comprises abrasive particles that are embedded in a resin. Such abrasive particles consist, for instance, of sandstone, pumice stone, quartz, corundum, silicon carbide or similar hard materials. They cause the actual grinding- or cleaning-effect of the grinding and cleaning body. For the secure fixation of the abrasive particles to the base body they are embedded in a resin. Typically, abrasive particles comprise a defined particle size, so that the grinding effect of the grinding and cleaning body can be adapted to the material to be grinded and to the desired surface roughness as well as to the removal rate.

In a further preferred embodiment, the processing layer comprises a resin coating without abrasive particles or without cleaning powder, respectively. If the flooring shall not be grinded, but only cleaned from tightly adhering dirt, the processing layer only needs to comprise a resin coating without cleaning powder and abrasive particles. This powder-free resin coating may, for example, be executed open-cell or fleece-like. By doing so, a good cleaning effect is achieved by the resin coating, wherein the surface of the flooring is not affected and thus is conserved. In particular, tightly adhering wax layers can be easily removed thereby.

Preferably, the processing layer is flocked, in particular with an artificial or a natural fiber, or it is flocked with particles of melamine resin foam. A flocking with artificial or natural fibers or with particles of melamine resin foam also increases the cleaning effect of the grinding and cleaning body and reaches, in particular, also the bottom of very fine and deep structures of the flooring, without damaging the flooring. Hereby, tightly adhering dirt or old wax layers, respectively, can be removed also from deepenings of the flooring without affecting the surface of the flooring.

In a preferred embodiment, the base body and the processing layer consist of at least one resilient rubber-like material, wherein the processing layer or the processing layer and the base body being interspersed with abrasive particles. By doing so, in particular, floor grinding- and cleaning-bodies with comparatively small burls can be manufactured in which the abrasive material is “rubber bounded”, i.e. embedded in a rubber-like elastic material. Such grinding and cleaning bodies are, in particular, suitable for processing of floors with low surface structure, for instance a hammer blow structure. It is advantageous that rubber bounded floor grinding- and cleaning-bodies comprise a very long life time. Besides that, they can be produced easily by injection molding without any further coating processes being necessary.

The above-mentioned problem is also solved by a floor grinding- and cleaning-body for machine-based processing of structured floorings comprising a base body which is provided on a first side with a resilient, textured surface, a processing layer that is arranged on the textured surface of the base body, wherein the processing layer comprises abrasive particles that are embedded in a resin, wherein the textured surface comprises a resilient burling structure, wherein the burls thereof are designed to be able to treat deep areas of a structured surface of a flooring.

Also here it is possible to reach deeper areas of a structured flooring with a floor grinding- and cleaning-body and thus to grind or to clean them in a machine-based manner, since the processing layer is arranged on a textured, resilient surface of the base body. The resilient texture presses the processing layer into the deep areas of the floor structure. By means of the abrasive particles that are embedded in a resin material—or in a similar material—a defined cleaning- or grinding-effect is achieved that can be adapted exactly to the respective material and the desired grinding- or cleaning-task. In addition, it is ensured by the embedding that the abrasive particles adhere safely even during dynamic load, due to the resilient textured surface and the intrusion in lower structures, thereby ensuring a good life time of the floor grinding- and cleaning-body. In particular, such floor grinding- and cleaning-bodies are appropriate for big and heavy floor treating machines that comprise a bristle disc. Here, the floor grinding- and cleaning-body is simply placed on the floor, and then the floor treating machine is put on top of the floor grinding- and cleaning-body. Then, the bristle disc moves the floor grinding- and cleaning-body along with it via friction fit. Here, a hook-and-loop connection is not necessary.

Preferably, the burls comprise a pyramid-shape, a pyramid-frustum shape, a cone shape, a cone-frustum shape or in cross-section a wave-shape. Comparatively pointed elevations of the burls result for the pyramid-shape and the cone-shape, so that fine-structured floorings can be processed in a better manner. The pyramid-frustum shape and the cone-frustum shape lead to a flattened tip, which is advantageous for more rough-structured floorings, in particular for burling floorings. Also, the removal rate of such burl-shapes is better than with pointed shapes. The burls, which comprise wave-shape, as seen in the cross-section, comprise a rounded tip and then change into a more blunt burling area. Thus, the burls are appropriate for fine floorings as well as for more rough-structured floorings. The wave-shape is also particularly simple to manufacture.

Preferably, the burls comprise a height of 2 mm to 50 mm, more preferably a height of 10 mm to 20 mm. Such dimensions lead to a good ratio between the flexibility of the burls and the stiffness of the burls that is necessary for the cleaning effect.

Preferably, the burls comprise a distance between each other of 3 mm to 50 mm, even more preferably 10 mm to 20 mm. With such distances, the used floor grinding- and cleaning-body can be optimally adapted to the specific flooring. By doing so, it is ensured, on the one hand, that also fine deepenings of the flooring can be processed, but, on the other hand, also a high removal rate on the surface is given.

Preferably, the base body consists of a resilient foam material. Such a resilient foam material can be easily manufactured in the desired degrees of hardness and with the desired textured surface. Furthermore, the resilient foam material can be provided or coated with a processing layer very well.

Preferably, the foam material comprises a compression resistance according to DIN 53577 and ISO 3386, respectively, of 20-60 (2-6 kPa at 40% material compression). Thus, the foam material is, on the one hand, soft enough for pressing the burls with the processing layer into the deepenings of the flooring and, on the other hand, this compression resistance ensures a sufficient down force and thus a good removal rate.

Preferably, the base body comprises a thickness of 10 mm to 60 mm, more preferably of 15 mm to 30 mm and even more preferably of 20 mm to 25 mm. By such thicknesses of the base body, the required resilience of the floor grinding- and cleaning-body is provided which ensures that the processing layer is able to penetrate into deeper areas of the structured surface with the necessary pressure, while other structured surface areas of the processing layer are able to process more elevated areas of the flooring.

Preferably, the base body consists of a resilient polymer material. Instead of a foam material, also a resilient polymer material can be used for the base body with the profiled surface. Then, the burls can preferably be provided with resilient bellows.

Preferably, the hook-and-loop adaption layer comprises a hook-and-loop velour layer. A hook-and-loop velour layer connects with a hook layer of a hook-and-loop system very well and thus provides a good, slip-free force transmission from the machine to the floor grinding- and cleaning-body.

In a preferred embodiment, the processing layer comprises an elastic abrasive particle carrier—in particular a fiber fleece—that covers the burls and is coated with abrasive particles. By the use of the elastic abrasive particle carrier, the life time of the floor grinding- and cleaning-body is increased, in particular, if a comparatively soft foam material is used for the base body.

In a preferred embodiment, the floor grinding- and cleaning-body is realized as a round disc, as a rectangular blank or in a delta-format. Thus, the floor grinding- and cleaning-body can be adapted to every machine that is used in combination with it.

The above-mentioned problem is also solved by a method for machine-based processing of structured floorings, comprising the following steps:

providing a floor cleaning machine or a floor grinding machine;

providing of a floor grinding- and cleaning-body with a base body that is provided on a first side with a resilient textured surface and which comprises a processing layer which is arranged on the textured surface of the base body, wherein the resilient, textured surface comprises a burling structure, wherein the burls thereof are designed to be able to process deep areas of a structured surface of a flooring;

fixing the floor grinding- and cleaning-body to the floor cleaning machine or the floor grinding machine;

processing the structured flooring with the floor cleaning machine or the floor grinding machine, wherein the burls of the resilient textured surface of the floor grinding- and cleaning-body penetrate into deep areas of the structured flooring in order to process it there.

Also here, deep areas of a structured flooring can be reached by the floor grinding- and cleaning-body and thus the entire surface of the flooring, in particular also the valleys of the structuring down to the bottom, can be grinded or machine cleaned with a floor treating machine, because the processing layer is arranged on a structured resilient surface of the base body. Thus, also a flooring with structured surface can be thoroughly cleaned and grinded completely, which was up to now only possible for the elevated areas of the flooring.

Preferably, the step of fixing the floor grinding- and cleaning-body to a floor cleaning machine or to a floor grinding machine comprises the step of mere putting the floor cleaning machine or the floor grinding machine on top of the floor grinding- and cleaning-body lying on the floor. The fixation of the floor grinding- and cleaning-body to the floor cleaning machine can be done by merely placing the machine onto the floor grinding- and cleaning-body, since it is usually heavy enough to move the floor grinding- and cleaning-body by friction fit along with it. A possibly present bristle disc of the floor cleaning machine supports this fixation by friction fit. Hook-and-loop systems are not necessary here.

Preferably, an above-described floor grinding- and cleaning-body for machine-based processing of structured floorings is used by means of a floor treating machine or a hand grinding machine.

### 4. SHORT DESCRIPTION OF THE FIGURES

In the following, preferred embodiments of the present invention are explained by means of the accompanying figures, in which shows:

FIG. 1: Floor grinding- and cleaning-body according to the invention in a perspective view;

FIG. 2: a cross-sectional view of the floor grinding- and cleaning-body according to the invention of FIG. 1;

FIG. 3: a cross-sectional view of a further embodiment of a floor grinding- and cleaning-body according to the invention;

FIG. 4: a cross-sectional view of the floor grinding- and cleaning-body of FIG. 1 with a flocking;

FIG. 5: a cross-sectional view of a further embodiment of the floor grinding- and cleaning-body according to the invention with an elastic abrasive particle carrier;

FIG. 6: a cross-sectional view of a further embodiment of the floor grinding- and cleaning-body according to the invention, with burls comprising bellows;

FIG. 7A-E: different burl shapes for a floor grinding- and cleaning-body according to the invention;

FIG. 8: a cross-sectional view of single burls of a floor grinding- and cleaning-body according to the invention, during processing a first exemplary structured flooring; and

FIG. 9: a cross-sectional view of single burls of a floor grinding- and cleaning-body according to the invention, during processing of a further exemplary structured flooring.

### 5. PREFERRED EMBODIMENTS

In the following, preferred embodiments of the present invention are described by means of the accompanying figures. Features of single embodiments can be combined with features of other embodiments, even when this is not expressly explained.

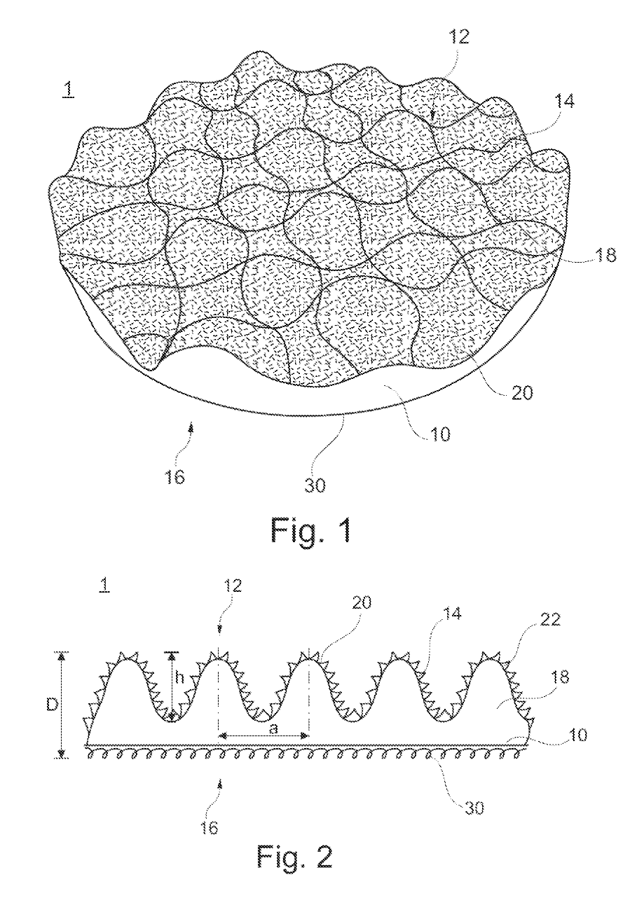

FIGS. 1 and 2 show a floor grinding- and cleaning-body according to a first embodiment. The floor grinding- and cleaning-body 1 comprises a base body 10 which is provided on a first side 12 with a resilient textured surface 14. On the surface 14, a processing layer 20 is arranged which gets into contact with the surface of the flooring during use and causes the actual cleaning and grinding effect. On a second side 16 opposed to the first side 12 of the base body, in this embodiment, a hook-and-loop adaption layer 30 is fixed. By means of this hook-and-loop adaption layer the floor grinding- and cleaning-body 1 can be fixed tightly but detachably to a grinding or cleaning machine.

As shown schematically in FIG. 2, the textured surface 14 consists of a multitude of resilient burls 18. These consist preferably of the same material as the remainder of the base body 10 and are realized unitarily with the remainder of the base body 10. However, they can also be made of another material. Preferably, a resilient foam material is used for the material of the base body 10. This can for instance consist of foamed soft polyurethane or also of foamed caoutchouc. The foam material is elastic and comprises a compression resistance according to DIN 53577 or ISO 3386, respectively, of 20-60. This corresponds to a pressure of 2-6 kPa at 40% compression of the foam material.

The shape of the burls 18 can differ depending on the use case. The person skilled in the art will design the floor grinding- and cleaning-body in that the burling structure is adapted to the surface structure of the floor and that an effective, optimum and complete processing of the floor becomes possible. Therefore, the person skilled in the art will select, among other things, the shape of the burls, the elasticity of the burled base body, the arrangement of the burls to each other, their distance from each other and the size of the burls according to the structuring of the respective flooring.

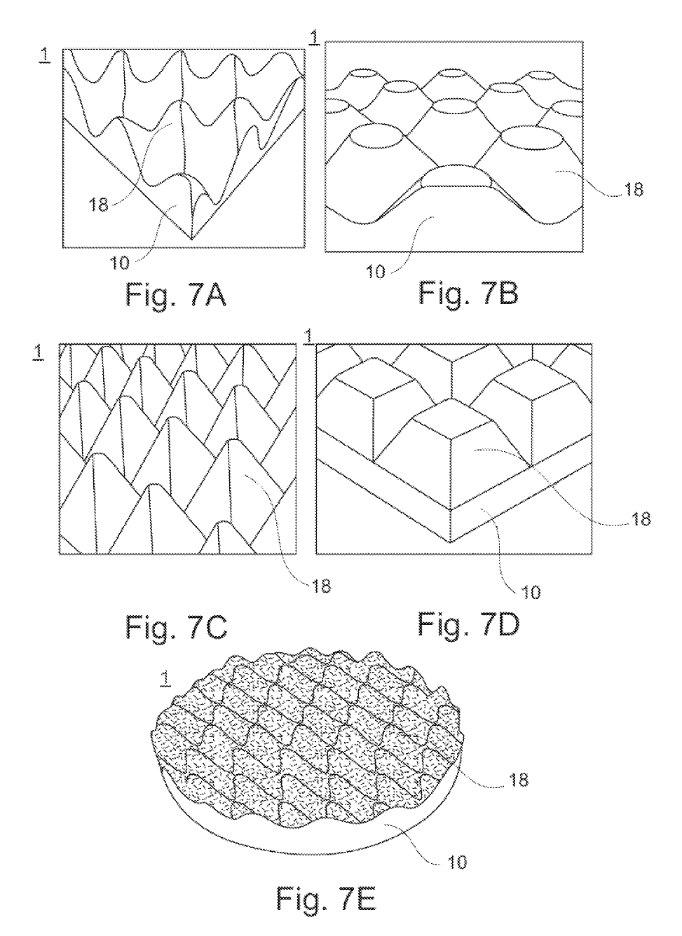

In FIG. 1, the shape of the burls is, in cross-section, a wave-shape. Other burl shapes are shown in FIGS. 7A-E, wherein FIG. 7A shows a base body 10 with cone-shaped burls 18, FIG. 7B shows a base body 10 with cone-frustum-shaped burls 18, FIG. 7C shows a base body 10 with pyramid-shaped burls 18, FIG. 7D a base body 10 with pyramid-frustum-shaped burls 18 and FIG. 7E again shows a base body 10 with wave-shaped burls 18 in cross-section. However, the burls 18 may comprise also other shapes and mixed shapes of the shown shapes. For the processing of a polymer floor with shale-structure, advantageously a burling structure will be chosen that is realized more pointed, for instance a pointed pyramid structure or a cone structure, whilst for the processing of a flooring with hammer blow structure or round-burl structure one will rather use a burl that comprises a tip that is more round-shaped. If rather a high removal rate is needed for the floor grinding- and cleaning-body 1, a burl shape having a flat tip should be chosen, for instance, a cone-frustum- or a pyramid-frustum shape. By doing so, the contact area of the burl 18, that is coated with abrasive particles, to the floor is larger than for pointed burl shapes, and the grinding is thus more intensive.

Common heights h of the burls 18 are in the range from 2 mm-50 mm, preferably 10 mm-20 mm. Such heights provide, on the one hand, the necessary resilience and flexibility of the burls 18, but they are chosen in that, simultaneously, the stiffness and stability of the burls 18 are given, which is necessary for the cleaning and grinding effect. Preferably, the burls 18 are arranged, as shown in FIG. 1, in a regular pattern at the surface 14, wherein the distance a of the burls from each other is preferably in the range from 3 mm-50 mm. The smaller the distance a is chosen, the higher is the removal rate of the floor grinding- and cleaning-body 1. Also a distance a of 10 mm-20 mm has proven to be successful for particular grinding and cleaning tasks.

Common thicknesses D of the base body 10 are in the range from 10 mm-60 mm, preferably 15 mm-30 mm, and even more preferably 20 mm-25 mm. The thickness D of the base body 10, the height h of the burls 18 and their distance a is chosen in that the compression of the burls 18 during the use of the floor grinding- and cleaning-body 1 is in the range for the necessary down force of the machine to the floor—or in general onto the work piece—that allows, on the one hand, a sufficiently high removal of the material and, on the other hand, also a sufficient penetration into the deep areas of the surface structure. Tests have shown that a compression of the burls of 30-70% provides sufficient grinding and cleaning results for structured polymer floors. Thus, the textured surface 14 of the floor grinding- and cleaning-body 1 can adapt itself to the structure of the flooring, so that the grinding pressure is approximately equal on the entire grinding surface that means in view of the elevations, the valleys and transitions of the surface structure.

The hook-and-loop adaption layer 30 can be made of a hook-and-loop velour or a hook-and-loop fleece which is glued to the second side 16 of the base body 10 with an appropriate adhesive. The floor grinding- and cleaning-body 1 can be fixed to a grinding disc or a grinding means holder via the hook-and-loop adaption layer 30.

In the embodiment that is shown in FIG. 1 the processing layer 20 consists of sharp-edged abrasive particles 22, that are embedded in a resin or another sufficient adhesive agent that coats the burls 18. These adhesive particles 22 consist for example of sand stone, pumice stone, quartz, corundum, silicon carbide, diamond or similar hard materials. The grinding- and cleaning-effect of the floor grinding- and cleaning-body 1 according to the invention can be adapted by the size of the abrasive particles. For grinding of old PU-coatings from polymer floors corresponding rough abrasive particles 22 of a particle size K120-K150 are used, and for the cleaning of polymer floors, that comprise little walking marks and are over-maintained strongly, relatively fine abrasive particles 22 with a particle size of K180-K400 or even more fine particles are used. For floors made of natural stone, for example floors made of marble, diamond has been proven as an advantageous coating means.

When the floor only shall be cleaned or polished, the floor grinding- and cleaning-body 1 according to the invention can also be provided with a coating without abrasive particles 24 on the textured and respectively burled surface 12. This coating 24 may be for example a resin coating without abrasive particles. This coating 24 can be realized in an open-cell manner or in a fleece-like manner. It is also possible to flock the surface 12 for instance with polyester or polyamide fibers in order to clean or to polish the floor. A flocking with open-cell particles made of melamine resin foam improves also the cleaning effect of the grinding- and cleaning-body. Thereby, the burls reach also the ground of fine structures of the flooring. With these coatings, strong-adhering dirt and old wax-layers respectively can also be removed very well from deepenings of the flooring without affecting the surface of the flooring.

As shown in FIG. 5, it is also possible to coat the textured surface 14 of the base body 10 with an adaptable abrasive particle carrier 26 that is coated in return with abrasive particles 22. This embodiment is in particular used for intensive cleaning- or grinding-tasks, for which relatively rough abrasive particles 22 are needed. The rough abrasive particles 22 can be fixed better to the abrasive particle carrier 26 than to the base body 10 itself. Furthermore, the abrasive particle carrier 26 provides the floor grinding- and cleaning-body 1 with a better stability at the grinding surface. Preferably, a fiber fleece is used as abrasive particle carrier 26.

FIG. 6 shows a floor grinding- and cleaning-body 1 wherein the base body 10 consists of a resilient polymer material. Herein, the burls 18 are for example realized by a hollow, blow molded polymer material with resilient bellows 19. These burls 18 can be coated with the different processing layers 20, with or without abrasive particles 22, flocking 24 and respectively with and without abrasive particle carrier 26 as described above. For such a floor grinding- and cleaning-body 1 an optimum adaption of the single burls 18 in view of elasticity, shape and arrangement onto the surface structure of the flooring to be processed is possible. Also here a constant grinding pressure onto all surface areas of the flooring is ensured.

Besides, the base body 10 and the processing layer 20 may also consist of a resilient rubber-like material. The rubber-like material of the base body 10 can be different to the material of the processing layer 20. But both layers can be also made of the same rubber-like material. A preferred material is rubber-like polyurethane. In particular, the processing layer 20 for itself or the processing layer 20 and the base body 10 can be interspersed completely by abrasive particles 22. Thus, the abrasive particles 22 are “rubber bounded” that means directly inserted and embedded into the rubber-like elastic material, so that coating processes can be omitted.

It should be mentioned that floor grinding- and cleaning-bodies 1 according to the invention are of course appropriate in the same way also for processing of structured and plain polymer-, caoutchouc- and wood-floors, in particular plank floors, marble- and fine stone floors. Further applications of floor grinding- and cleaning-bodies 1 are the grinding of uneven and structured surfaces for instance in the aircraft manufacturing.

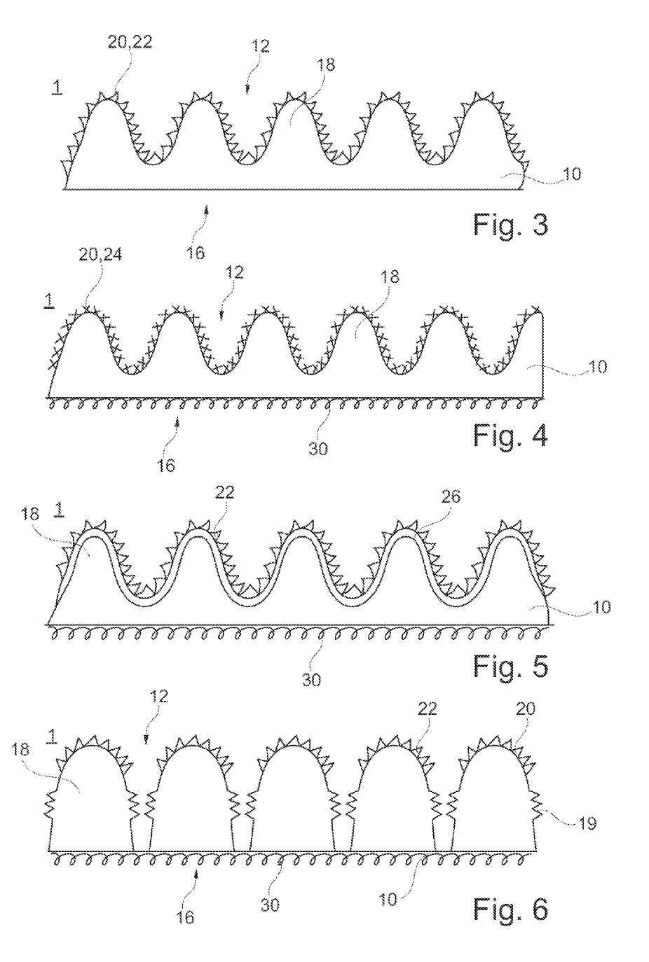

FIG. 3 shows a further embodiment of a floor grinding- and cleaning-body 1 according to the invention. In this embodiment the second side 16 is not provided with a hook-and-loop adaption layer 30. This embodiment is thus in particular appropriate for floor treating machines that comprise one or more spinning discs. Therefore, the floor treating machines (in particular a floor cleaning machine) can be simply put on top of the floor grinding- and cleaning-body 1 that lies on the floor, so that it is moved together by friction fit of the corresponding spinning disc. In order to improve the friction the spinning disc can be provided on its bottom side with bristles that intrude into the second side 16 of the base body 10. A fixation via a hook-and-loop system is not necessary in this case.

Floor grinding- and cleaning-bodies 1 according to the invention are in particular appropriate for the use with such floor treating machines but they can also be used with other grinding machines, for instance with hand grinding machines. In every case, the outer shape of the floor grinding- and cleaning-body 1 is then adapted to the shape of the specific tool-holder of the grinding machine. Common shapes are round, rectangular or the so called delta-format. For the use with single disc floor processing machines the floor grinding- and cleaning-bodies 1 comprise a round shape and a diameter corresponding to the machine of 370 mm-500 mm.

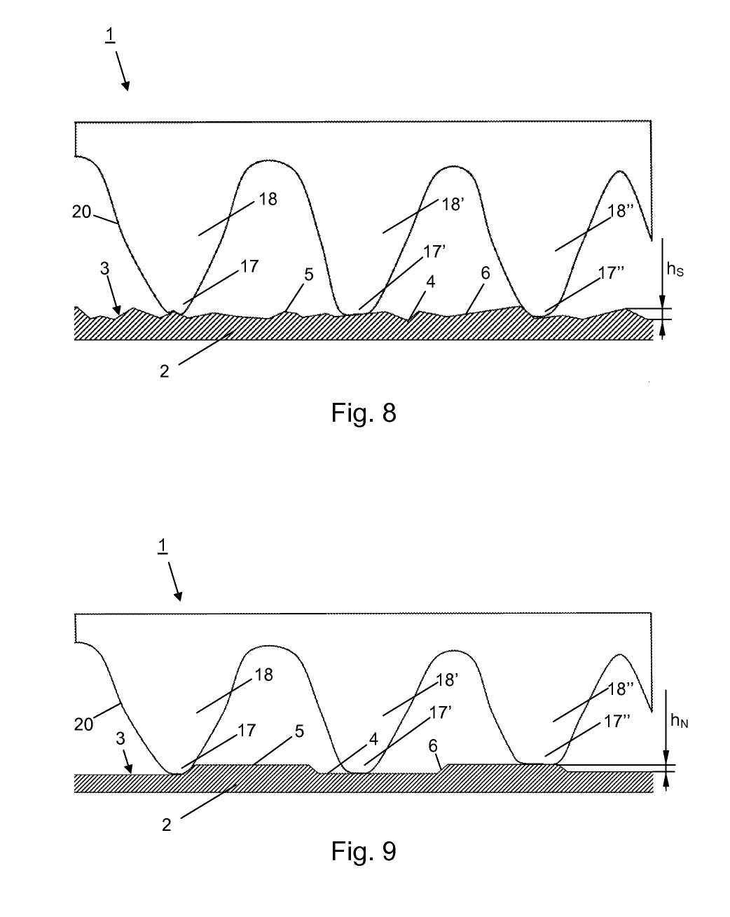

The cross sectional views of FIGS. 8 and 9 show the physical processes of burls 18 of the floor grinding- and cleaning-bodies 1 during the processing of floorings 2. Therefore, FIG. 8 shows a flooring 2 with an unsteady structured surface 3, perhaps in form of a shale- or wood-surface. The height hₛ of the structures of the structured surface are depending on the structure for instance in the range of 0.5-3.0 mm. The structured surface 3 comprises valleys 4, mountains 5 and transitions 6.

As shown in FIG. 8, the tips 19, 19′, 19″ of the burls 18, 18′, 18″ always contact the surface 3 of the flooring 2, while the burl 18 actually passes a mountain 5, the burl 18′ simultaneously processes a transition 6 and burl 18″ contacts the ground of a valley 4. The resilience of the base body 10 and the burl shape allow that the tips 17, 17′, 17″ of the burls 18, 18′, 18″ adapt themselves to the specific surface structure and processes the surface 3 by means of the processing layer 20 completely. Herein the tips 17, 17′, 17″ move in some kind of a roller coaster ride along the contour of the structured surface 3. In general, ordinary plain grinding- or cleaning-bodies would contrary to that—even when they are realized in a resilient manner—not reach the ground of the valleys 4 and thus could only process the tips of the mountains 5.

FIG. 9 shows a flooring 2 wherein the mountains 5 are realized as round burls and the valleys are plain areas between the round burls and the transitions 6 are in general cone-shaped surfaces of the round burls. The height h_{R} of the round burls is for instance in the range of 0.5-2.0 mm. As shown, the tip 17 of burl 18 actually processes the transition 6 to a round burl 5, wherein simultaneously the tip 17′ of the burl 18′ processes the ground of the valley 4 and the tip 17″ of the burl 18″ processes the upper plain of the round burl 5. During the relative movement of the grinding- and cleaning-body 1 in relationship to the structured flooring 2 the burls 18, 18′, 18″ are compressed differently strong during their roller coaster ride over the surface 3 and contact with the processing layer 20 always the structured surface 3 such that not only the tips of the mountains 5 but also the valleys 4 can be processed down to their bottom and the transitions 6.

### LIST OF REFERENCE NUMBERS

1 Floor grinding- and cleaning-body
2 Structured flooring
3 Structured surface
4 Valley
5 Mountain
6 Transition
10 Base body
12 First side
14 Resilient, textured surface
16 Second side
17 Tip of a burl
18 Resilient Burls
19 Bellows
20 Processing layer
22 Abrasive particles
24 Coating without abrasive particles, flocking
26 Abrasive particle carrier
30 Hook-and-loop adaption layer

1. Floor grinding- and cleaning-body (1) for machine-based processing of structured floorings (2), comprising:
a. a base body (10), which is provided on a first side (12) with a resilient, textured surface (14);
b. a processing layer (20), that is arranged on the textured surface (14) of the base body (10); and
c. a hook-and-loop adaption layer (30), which is arranged on a second side (16) of the base body (10) opposed to the first side (12); wherein
d. the textured surface (14) comprises a resilient burling structure, wherein the burls (18) thereof are designed to be able to treat deep areas (4) of a structured surface (3) of a flooring (2).

2. Floor grinding- and cleaning-body according to claim 1, wherein the processing layer (20) comprises abrasive particles (22) that are embedded in a resin.

3. Floor grinding- and cleaning-body according to claim 1, wherein the processing layer (20) comprises a resin coating (24) without abrasive particles.

4. Floor grinding- and cleaning-body according to claim 1, wherein the processing layer (20) is flocked, in particular flocked with an artificial or a natural fiber (24) or wherein the processing layer (20) is flocked with particles made from a foam of melamin resin.

5. Floor grinding- and cleaning-body according to claim 1, wherein the base body (10) and the processing layer (20) consist of at least one resilient rubber-like material, wherein the processing layer (20) and the base body (10) is/are interspersed with abrasive particles.

6. Floor grinding- and cleaning-body (1) for machine-based processing of structured floorings, comprising:
a. a base body (10), which is provided on a first side (12) with a resilient, textured surface (14);
b. a processing layer (20) that is arranged on the textured surface (14) of the base body (10);
c. the processing layer (20) comprises abrasive particles (22) embedded in a resin, wherein
d. the textured surface (14) comprises a resilient burling structure, wherein the burls (18) thereof are designed to be able to treat deep areas (4) of a structured surface (3) of a flooring (2).

7. Floor grinding- and cleaning-body according to claim 1 wherein the burls (18) comprise a pyramid shape, a pyramid frustum shape, a cone shape, a cone frustum shape or in cross-section a wave-shape.

8. Floor grinding- and cleaning-body according to claim 1, wherein the burls (18) comprise a height (h) of 2 mm-50 mm, preferably 10 mm-20 mm.

9. Floor grinding- and cleaning-body according to claim 1, wherein the burls (18), comprise a distance (a) to each other of 3 mm-50 mm.

10. Floor grinding- and cleaning-body according to claim 1, wherein the burls (18), are adapted to the structured surface (3) of the flooring (2) to be processed.

11. Floor grinding- and cleaning-body according to claim 1, wherein the base body (10) is consists of a resilient foam material.

12. Floor grinding- and cleaning-body according to claim 11, wherein the foam material comprises a compression resistance according to DIN 53577 and ISO 3386 respectively of 20 to 60.

13. Floor grinding- and cleaning-body according to claim 1, wherein the base body (10) comprises a thickness of 10 mm-60 mm.

14. Floor grinding- and cleaning-body according claim 1, wherein the base body (10) consists of a resilient polymer material.

15. Floor grinding- and cleaning-body according to claim 14, comprising burls (18) that comprise resilient bellows (19).

16. Floor grinding- and cleaning-body according to claims 1, wherein the hook-and-loop adaption layer (30) comprises a hook-and-loop velour layer.

17. Floor grinding- and cleaning-body according to claim 1, wherein the processing layer (20) comprises an elastic abrasive particle carrier (26), in particular a fiber fleece, that covers the burls (18) and which is coated with abrasive particles (22).

18. Floor grinding- and cleaning-body according to claim 1, wherein the grinding- and cleaning-body is realized as round disc, as rectangular blank or in a delta-format.

19. Method for machine-based processing of structured floorings, comprising the following steps:
a. providing a floor cleaning machine or a floor grinding machine;
b. providing a floor grinding- and cleaning-body (1) with a base body (10), which is provided on a first side (12) with a resilient textured surface (14) having a burling structure and which comprises a processing layer (20) that is arranged on the textured surface (14) of the base body (10), wherein the resilient, textured surface (14) comprises a burling structure, wherein the burls (18) thereof are designed to be able to treat deep areas (4) of a structured surface (3) of a flooring (2);
c. fixing the floor grinding- and cleaning-body (1) to the floor cleaning machine or the floor grinding machine; and
d. processing the structured flooring with the floor cleaning machine or the floor grinding machine, wherein the burls (18) of the resilient burling structure (14) of the floor grinding- and cleaning-body (1) penetrate into deep areas (4) of the structured flooring (2) in order to process it there.

20. Method according to claim 19, wherein the step of fixing the floor grinding- and cleaning-body (1) to the floor cleaning machine or the floor grinding machine comprises the step of mere putting the floor cleaning machine or the floor grinding machine on top of the floor grinding- and cleaning-body (1) lying on the floor.

21. (canceled)
